(19) United States
(12) Patent Application Publication
(10) Pub. No.: US 2014/0026607 A1
(43) Pub. Date: Jan. 30, 2014

(54) DRAIN PAN LINER WITH A TEXTURED SURFACE TO IMPROVE DRAINAGE

(71) Applicant: Michael J. Schuetter, Columbus, GA (US)

(72) Inventor: Michael J. Schuetter, Columbus, GA (US)

(21) Appl. No.: 13/561,851

(22) Filed: Jul. 30, 2012

(51) Int. Cl. F25D 21/14; B29C 51/26; B32B 37/02; A47F 3/04; B29C 51/00

(52) U.S. Cl. 62/246; 62/291; 264/319; 156/60; 264/162

(57) ABSTRACT

A drain pan liner for a refrigeration system, comprising a layer configured to be located underneath frost accumulating components of a cooling unit of a refrigeration system. The layer includes a homogenously textured surface configured to receive water from the cooling unit, wherein the homogenously textured surface has a uniform distribution of uniformly dimensioned and separated peaks and valleys.

### TECHNICAL FIELD

This application is directed, in general, to refrigeration systems, and more specifically, to a drain pan liner and method of manufacturing the drain pan liner.

### BACKGROUND

Refrigeration systems accumulate frost on components which must then be periodically defrosted. The resulting defrost water is accumulated in a drain pan liner and then drained away by the force of gravity. If the defrost water does not fully drain away during the defrosting period, however, ice can build up on the refrigeration components and on the liner, thereby causing the refrigeration system to perform its cooling function inefficiently, and in some cases, to malfunction. This, in turn, can result in the spoilage of items being stored in the refrigeration system and/or require the extended shutdown of the refrigeration system to remove the accumulated ice and restart the refrigeration system.

### SUMMARY

One embodiment of the present disclosure is a drain pan liner for a refrigeration system, comprising a layer configured to be located underneath frost accumulating components of a cooling unit of a refrigeration system. The layer includes a homogenously textured surface configured to receive water from the cooling unit, wherein the homogenously textured surface has a uniform distribution of uniformly dimensioned and separated peaks and valleys.

Another embodiment of the present disclosure is a refrigeration system, comprising a display case, the display case having an upper display space and a lower component space, a cooling unit located in the lower component space, and the above-described a drain pan liner.

Another embodiment of the present disclosure is a method of manufacturing a drain pan liner for a refrigeration system, comprising forming the above-described layer.

### BRIEF DESCRIPTION

Reference is now made to the following descriptions taken in conjunction with the accompanying drawings, in which:

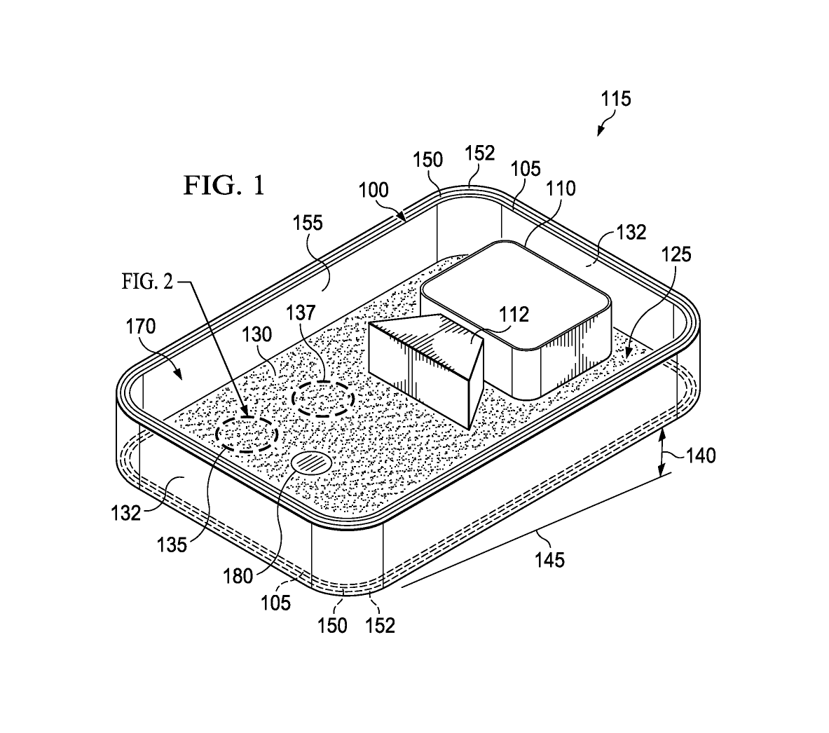

FIG. 1 illustrates a perspective view of an example drain pan liner of the disclosure;

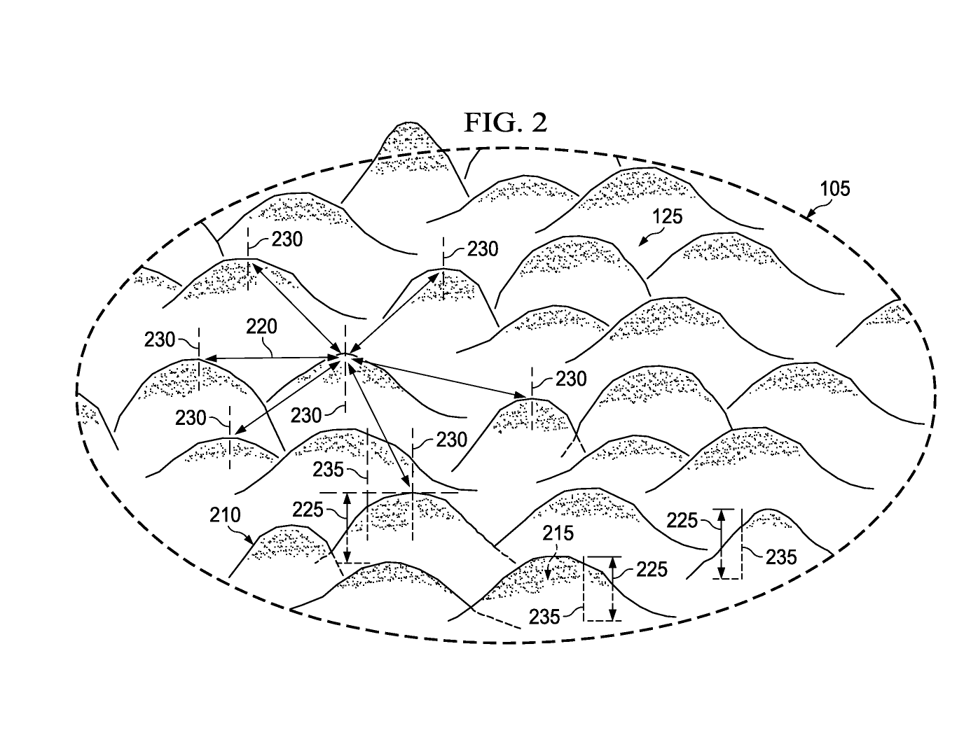

FIG. 2 presents a detailed perspective view of the homogenously textured surface of an example layer of the drain pan liner of the disclosure such as the example layer depicted in FIG. 1;

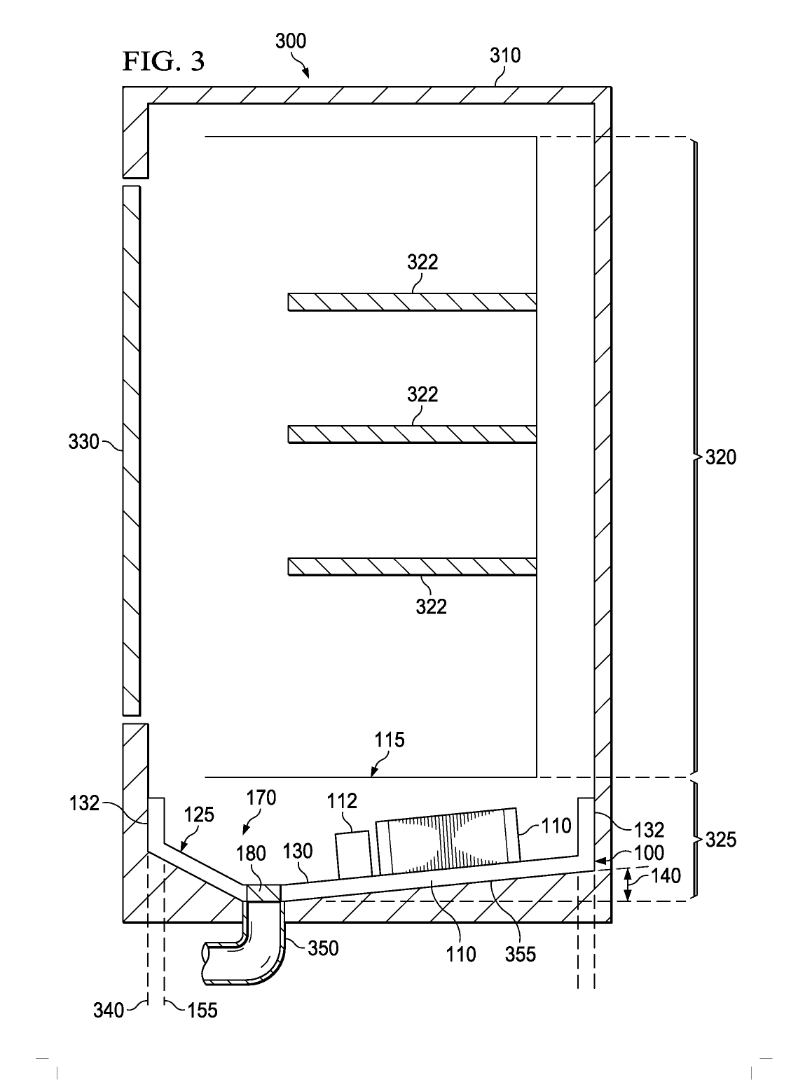

FIG. 3 illustrates a cross-sectional side view of an example refrigeration system that includes an example drain pan liner of the disclosure, such as the example drain pan liner depicted in FIGS. 1-2; and

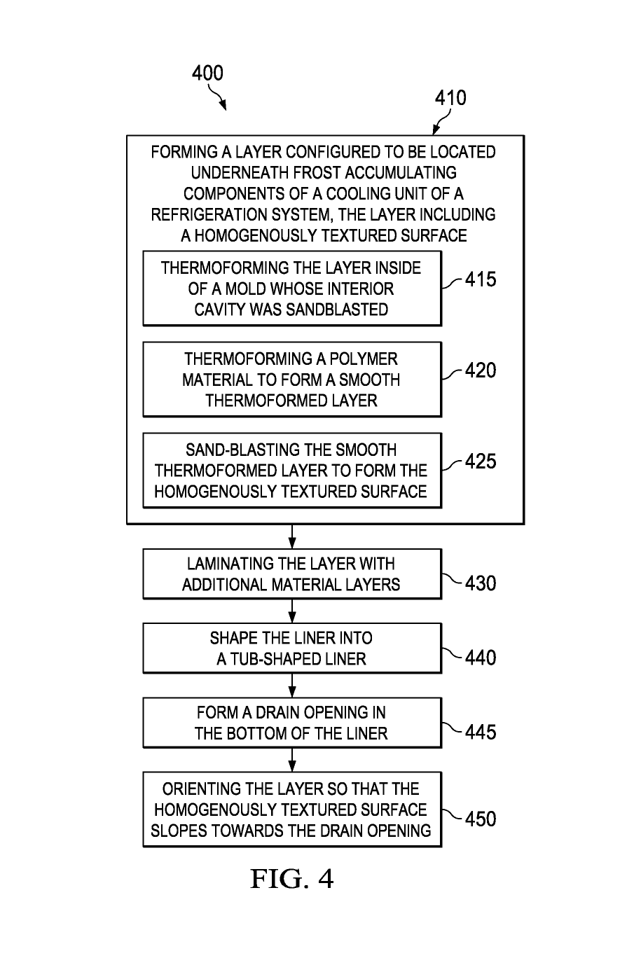

FIG. 4 presents a flow diagram of an example method of manufacturing the drain pan liner of the disclosure, such as any of the drain pan liners discussed in the context of FIGS. 1-3.

### DETAILED DESCRIPTION

The term, “or,” as used herein, refers to a non-exclusive or, unless otherwise indicated. Also, the various embodiments described herein are not necessarily mutually exclusive, as some embodiments can be combined with one or more other embodiments to form new embodiments.

As part of the present disclosure, it was discovered that providing a drain pan liner with a homogenous textured surface imparts the surface with a substantially reduced water flow resistance, and hence improved drainage of water from the liner.

One embodiment of the disclosure is a drain pan liner for a refrigeration system. FIG. 1 illustrates a perspective view of an example drain pan liner 100 of the disclosure.

As illustrated in FIG. 1, the drain pan liner 100 comprises a layer 105 configured to be located underneath frost-accumulating components (e.g., an evaporator assembly 110, and air mover assembly 112) of a cooling unit 115 of a refrigeration system 120. The layer 105 includes a homogenously textured surface 125 configured to receive water from the cooling unit 115 (e.g., defrost water).

The term drain pan liner 100 as used herein refers to any structure designed to capture water, e.g., defrost water from diverse surfaces and components of a refrigeration system. In some cases, to facilitate the capture and drainage of water, an entire side 130 of the layer 125, e.g., a bottom side 130 the liner 100, that is configured to receive the defrost water, has the homogenously textured surface 125 thereon. In other cases, such as when defrosted water accumulates in specific isolated locations, then only a portion of the layer 105 may have the homogenously textured surface 125 in those locations of the side 130. In still other cases, the bottom side 130 and side walls 132 of the liner 100 can be covered with the layer 110, e.g., to facilitate broad capture of defrost water.

FIG. 2 presents a detailed perspective view of the homogenously textured surface 125 of the layer 105 of the drain pan liner 100 of the disclosure such as the example layer depicted in FIG. 1. As illustrated, the homogenously textured surface 125 has a uniform distribution of uniformly dimensioned and separated peaks 210 and valleys 215.

The term, peaks, as used herein refers to substantially isolated raised features of the surface 125, thereby forming peaks 210 that are separated from every other peak 210 on all sides by valleys 215.

The term uniformly dimensioned and separated peaks and valleys, as used herein refers to the peak-to-peak distances 220 of adjacent peaks, and peak-to-valley distances 225 of adjacent peaks and valley being substantially the same over the entire surface 125.

For example, in some embodiments of the liner 100, an average of the peak-to-peaks distances 220 within any one percent area (e.g., area 135) of the homogenously textured surface 125 is within 20 percent, and in some cases within 10 percent, and in some cases within 1 percent, of the average of the peak-to-peak distances 220 for any other different one percent area (e.g., area 137) of the homogenously textured surface 125.

For example, in some embodiments of the liner 100, an average of the peak-to-valley distances 225 within any one percent area of the homogenously textured surface is within 20 percent, and in some cases within 10 percent, and in some cases within 1 percent, of the average of the peak-to-valley distances 225 of any other different one percent area (e.g., area 137) of the homogenously textured surface 125

Having a homogenously textured surface 125 advantageously provides a uniformly low flow resistance on the entire surface 125, regardless of the particular direction that the water is flowing in, thereby improving water drainage. For example, referring to FIG. 1, for some embodiments of the liner 100, one or more water droplets placed on the homogenously textured surface 125 will move along the homogenously textured surface 125 when the layer 105 is tilted by a substantially same angle 140 (e.g., within 5 degrees, and within about 1 degree, in some embodiments) with respect to a horizontal planar surface 145, regardless of which direction the layer 105 is tilted in.

It is advantageous for the homogenously textured surface 125 to be configured so as to provide a minimum of water flow resistance. For instance, referring to FIG. 2, in some embodiments of the liner 100, a peak-to-peak distance 220 from a top 230 of any one of the peaks 210 to another top 230 of any one of the adjacent peaks 210, is in a range from about 50 to about 500 microns, and in some cases, from about 150 to about 250 microns. For instance, in some embodiments of the liner 100, a peak-to-valley distance 225 from a top 230 of any one of the peaks 210 to a trough 235 of any one of the adjacent valleys 215, is in a range from about 50 to about 500 microns, and in some cases, from about 150 to about 250 microns.

It is advantageous for the liner 100 to be composed of a material that is resistant to the cleaning products commonly used in residential and commercial sites, including ammonia and acid based cleaners. For instance, in some cases, the layer 105 is composed of a refrigeration grade polymer. Non-limiting examples include acrylonitrile butadiene styrene (ABS), polystyrene or polypropylene or similar polymers familiar to those skilled in the art. In other cases however the layer 105 can be composed of metals such as aluminum (e.g., galvanized aluminum) or steel (e.g., stainless steel).

In some embodiments, the liner 100 can be made of only the layer 105 with the homogenously textured surface 125. In other cases however, it can be advantageous for the liner 100 to further include additional layers to, e.g., impart greater mechanical strength or thermal insulating properties, than provided by the layer 105 alone. For example, in some embodiments, the liner 100 can further include a middle layer 150 of polyurethane and a bottom layer 152 of non-refrigeration-grade polymer (e.g., ABS, polystyrene or polypropylene or similar polymers) where the layers 105, 150, 152 are laminated together.

While not limiting the scope of the disclosure by theory, it is believed that the reduced water flow resistance provided by the disclosed homogenous textured surface 125 facilitates the water to directly contact substantially only on the tops 230 of the peaks 210.

This is in contrast to certain drain pan liners with poorer water drainage properties, which is thought to at least in part due to the high water flow resistance properties of the liner surface receiving the defrost water. Water resting on such liners is thought to directly contact a large portion of the liner surface area thereby provided a high flow resistance.

Consider, for example, materials such as galvanized aluminum or ABS polymer, which have smooth surfaces, e.g., surfaces that are substantially devoid of peaks and valleys of sizes disclosed for the homogenously textured surface 125. Sheets of galvanized aluminum or ABS polymer, were found to require a greater force of gravity (e.g., by tilting one end of the sheet above a planar surface) to cause droplets of water to move along the surface, as compared to material sheets having the disclosed homogenous textured surface.

Consider, for example, ABS polymer having a textured hair cell surface. The textured hair cell surface has a grainy appearance with long (e.g., greater than about 1 mm and in some cases greater than about 5 mm) striations thereon, the striations all extending in a same general direction along the surface. Therefore, such ABS polymers, with a textured hair cell surface, do not have a homogenously textured surface such as disclosed herein.

For instance, sheets of ABS polymer with the textured hair cell surface were found to require a greater force of gravity to cause droplets of water to move along the surface in the same direction as the general direction of the striations, as compared to material sheets having the disclosed homogenous textured surface. In comparison, sheets of ABS polymer with the textured hair cell surface were found to require about the same force of gravity to cause droplets of water to move along the surface in a direction that was perpendicular to the general direction of the striations, as compared to material sheets having the disclosed homogenous textured surface.

Another embodiment of the disclosure, is a refrigeration system. FIG. 3 illustrates a cross-sectional side view of an example refrigeration system 300 that includes an example drain pan liner of the disclosure, such as the example drain pan liner 100 depicted in FIGS. 1-2. A non-limiting example of such refrigeration systems includes the Kysor/Warren line of STRATUS reach-in display case types of refrigeration systems, for use in supermarkets (Heatcraft Refrigeration Products LLC, Stone Mountain, Ga.). Based upon the present disclosure, however, one of ordinary skill would appreciate that other types of refrigeration systems that could benefit from using the disclosed drain pan liner disclosed herein, including non-commercial and commercial refrigerators.

As illustrated in FIG. 3, the example refrigeration system 300 comprises a display case 310, the display case 310 having an upper display space 320 (e.g., with product shelves 322) and a lower component space 325. Some embodiments of the system 300 could include a door 330 to permit access to products in the upper display space 320. However in other embodiments the upper display space 320 may have no door.

The system 300 also comprises a cooling unit 115 located in the lower component space 325 and a drain pan liner 100. Any of the embodiments of the drain pan liner 100 discussed in the context or FIGS. 1-2 could be used in the refrigeration system 300. For instance, referring to FIGS. 1 and 2, the liner 100 includes a layer 105 configured to be located underneath frost accumulating components 110, 112 of the cooling unit 115, and the layer 105 includes a homogenously textured surface 125 configured to receive water from the cooling unit 115, wherein the homogenously textured surface has a uniform distribution of uniformly dimensioned and separated peaks 210 and valleys 215.

As illustrated in FIGS. 1 and 3, in some embodiments, the drain pan liner 100 is shaped as a tub that is configured to fit within an interior perimeter 340 of the display case 310 with the frost-accumulating components 110, 112 of the cooling unit 115 located above and within an interior perimeter 155 of the vertically oriented tub walls 150. In some cases, one or more of the frost-accumulating components 110, 112 can rest directly on the liner 100, and, in some cases, one or more of the frost-accumulating components 110, 112 can be substantially located within an interior cavity 170 of the (e.g., tub-shaped) liner 100.

One of ordinary skill would be familiar with various types of frost-accumulating components such as an evaporator assembly 110 with internal evaporator coils, air mover assembly 112 with a fan (not shown) and other components upon which frost can form during the systems normal refrigeration cycle. One of ordinary skill would also be familiar with defrosting procedures for refrigeration systems 300, including programmed defrost cycles, e.g., using heating elements and air movers to speed up the melting of ice accumulated on the components 110, 112 when a refrigeration cycle is off. One of ordinary skill would appreciate that the liner 100 could have alternative shapes as needed to contain the melted ice as defrost water from the cooling unit 115.

In some cases, the side walls 132 and floor (e.g., bottom side 130 in FIG. 1) of the tub-shaped liner 100 can be made of a single continuous layer 110 with the homogenously textured surface 125. In such cases the homogenously textured surface 125 covers the entire interior cavity 170 of the tub-shaped liner 100. In other cases, only the floor or only a portion of the floor may have the layer 105 with the homogenously textured surface 125 (e.g., corresponding to side 130 of the layer 105).

As illustrated in FIGS. 1 and 3, in some embodiments the drain pan liner includes a drain opening 180 therein (e.g., in the floor of the tub-shaped liner in some cases). As illustrated in FIG. 3, the drain opening 180 can be configured to be connected to a drain pipe 350 passing through a bottom floor 355 of the display case 310.

As further illustrated in FIGS. 1 and 3, in some embodiments, the homogenously textured surface 125 is configured to be sloped down towards the drain opening 180, e.g., when the drain pan liner 100 is positioned in the display case 310. For example in some cases, the homogenously textured surface 125 on the floor 175 of liner 100 is sloped towards the drain opening 180 at an angle 140 having a value in a range from about 2 to about 6 degrees and in some cases from about 3 to about 4 degrees. As previously discussed in the context of FIGS. 1 and 2, the homogenously textured surface 125 facilitates the drainage of defrost water along the slope and into the drain opening 180.

Another embodiment of the present disclosure is a method of manufacturing a drain pan liner for a refrigeration system. FIG. 4 presents a flow diagram of an example method 400 of manufacturing the drain pan liner of the disclosure, such as any of the drain pan liners 100 discussed in the context of FIGS. 1-3.

With continuing reference to FIGS. 1-3 throughout, the method 400 comprises a step 410 of forming a layer 105 configured to be located underneath frost accumulating components 110, 112, of a cooling unit 115 of a refrigeration system 300. The layer 105 includes a homogenously textured surface 125 configured to receive water from the cooling unit 115. The homogenously textured surface 125 has a uniform distribution of uniformly dimensioned and separated peaks 210 and valleys 215.

In some cases, forming the layer 105 in step 410 includes a step 415 of thermoforming the layer 105 inside of a mold whose interior cavity was sandblasted. The sand-blasted mold has a homogenously textured surface that is a mirror image of the homogenously textured surface 125, and during the thermoforming step 415, this mirror image homogenously textured surface is transferred to the layer's 105 surface 125.

One of ordinary skill would understand how to adjust the size, hardness of the particles and the blasting velocity of the particles to provide the mirror-image homogenously textured surface and them impart homogenously textured surface 125 onto the layer 105. For example, in some cases, the mold can be a metallic mold (e.g., an Aluminum mold) whose interior cavity was sand blasted with particles having an average grit size value in range of about 80 to about 220, and in some cases, an average grit size of about 95.

In other cases, forming the layer 105 in step 410 includes a step 420 of thermoforming a polymer material (e.g., ABS, polystyrene or polypropylene or similar polymers) to form a smooth thermoformed layer and a step 425 of sandblasting the smooth thermoformed layer. In such embodiments of the method 400, the sand blasting step 425 directly imparts the homogenously textured surface 125 onto the layer 105.

One of ordinary skill would understand how to adjust the size, hardness of the particles and the blasting velocity of the particles to provide the homogenously textured surface 125. For example, in some cases, the thermoformed mold can be sand blasted with particles having an average grit size value in the range of about 80 to about 220, and in some cases, an average grit size of about 95.

One of ordinary skill would appreciate that there could be other processes to form the layer 105 with the homogenously textured surface 125, including chemical etching, mechanical punching or otherwise altering the surface of a mold used to form the layer, analogous to step 415, or, directly chemical etch, mechanical punch or otherwise alter the layer 105 to form the surface 125, analogous to step 425.

Some embodiments of the method 400 further include a step 430 of laminating together, the layer 105 with additional material layers (e.g., layers of polyurethane 150 and non-refrigeration grade polymer 152), to form a multilayered liner. For example, sheets of the layer 105, a middle layer 150 of polyurethane and a bottom layer 152 of non-refrigeration grade polymer can be co-extruded from a molding machine to form a multilayered liner 100.

Some embodiments of the method 400 further include a step 440 of shaping the liner 100 into a tub-shaped liner, e.g., by coupling one or more of the layers 105, 150, 155 together, or thermoforming a single layer 105, a step 445 of forming a drain opening 180 in the bottom of the liner (e.g., in the floor of a tub-shaped liner 100), and, a step 450 of orienting the layer 105 (e.g., by thermoforming the layer 105) so that the homogenously textured surface 125 slopes towards the drain opening 180.

Those skilled in the art to which this application relates will appreciate that other and further additions, deletions, substitutions and modifications may be made to the described embodiments.

What is claimed is:

1. A drain pan liner for a refrigeration system, comprising:
a layer configured to be located underneath frost-accumulating components of a cooling unit of a refrigeration system, the layer including a homogenously textured surface configured to receive water from the cooling unit, wherein the homogenously textured surface has a uniform distribution of uniformly dimensioned and separated peaks and valleys.

2. The liner of claim 1, wherein an entire side of the layer is configured to receive the water has the homogenously textured surface thereon.

3. The liner of claim 1, wherein an average of peak-to-peaks distances within any one percent area of the homogenously textured surface is within 20 percent of the average of the peak-to-peak distances for any other different one percent area of the homogenously textured surface.

4. The liner of claim 1, wherein an average of peak-to-valley distances within any one percent area of the homogenously textured surface is within 20 percent of the average of the peak-to-valley distances of any other different one percent area of the homogenously textured surface.

5. The liner of claim 1, wherein one or more water droplets placed on the homogenously textured surface will move along the homogenously textured surface when the layer is tilted by a substantially same angle with respect to a horizontal surface, regardless of which direction the layer is tilted in.

6. The liner of claim 1, wherein a peak-to-peak distance from a top of any one of the peaks to a second top of any one of the adjacent peaks, is in a range from about 50 to about 500 microns.

7. The liner of claim 1, wherein a peak-to-peak distance from a top of any one of the peaks to another top of any one of the adjacent peaks, is in a range from about 150 to about 250 microns.

8. The liner of claim 1, wherein a peak-to-valley distance from a top of any one of the peaks to a trough of any one of the adjacent valleys, is in a range from about 50 to about 500 microns.

9. The liner of claim 1, wherein a peak-to-valley distance from a top of any one of the peaks to a trough of any one of the adjacent valleys, is in a range from about 150 to about 250 microns.

10. The liner of claim 1, wherein the layer is composed of a refrigeration grade polymer.

11. A refrigeration system, comprising
a display case, the display case having an upper display space and a lower component space;
a cooling unit located in the lower component space;
a drain pan liner including a layer configured to be located underneath frost accumulating components of a cooling unit of a refrigeration system, the layer including a homogenously textured surface configured to receive water from the cooling unit, wherein the homogenously textured surface has a uniform distribution of uniformly dimensioned and separated peaks and valleys.

12. The system of claim 11, wherein the drain pan liner is shaped as a tub that is configured to fit within an interior perimeter of the display case with the frost-accumulating components of the cooling unit located above and within an interior perimeter of the vertically oriented tub walls.

13. The system of claim 11, wherein the refrigeration linear is shaped as a tub and the homogenously textured surface covers an entire interior cavity of the tub-shaped liner.

14. The system of claim 11, wherein the drain pan liner includes a drain opening therein, the drain opening configured to be connected to a drain pipe passing through a bottom floor of the display case.

15. The system of claim 14, wherein at least a portion of the homogenously textured surface is configured to be sloped down towards the drain opening.

16. A method of manufacturing a drain pan liner for a refrigeration system, comprising:
forming a layer configured to be located underneath frost accumulating components of a cooling unit of a refrigeration system, the layer including a homogenously textured surface configured to receive water from the cooling unit, wherein the homogenously textured surface has a uniform distribution of uniformly dimensioned and separated peaks and valleys.

17. The method of claim 16, wherein forming the layer includes thermoforming the layer inside of a mold whose interior cavity was sandblasted.

18. The method of claim 16, wherein forming the layer includes:
thermoforming a polymer material to form a smooth thermoformed layer; and
sandblasting the smooth thermoformed layer.

19. The method of claim 16, further including laminating together, the layer and additional polymer layers to form a multilayered liner.

20. The method of claim 16, further including:
shaping the liner into a tub-shaped liner;
forming a drain opening in the bottom of the liner; and
orienting the liner such that the homogenously textured surface slopes down towards the drain opening.
